(19) United States
(12) Patent Application Publication
(10) Pub. No.: US 2017/0359185 A1
(43) Pub. Date: Dec. 14, 2017

(54) METHOD FOR LOADING WEBSITE SECURITY INFORMATION AND BROWSER APPARATUS

(71) Applicant: BEIJING QIHOO TECHNOLOGY COMPANY LIMITED, Beijing (CN)

(72) Inventors: Cheng HANG, Beijing (CN); Yanwei SHI, Beijing (CN); Zhengqiang JIA, Beijing (CN)

(73) Assignee: BEIJING QIHOO TECHNOLOGY COMPANY LIMITED, Beijing (CN)

(21) Appl. No.: 15/541,314

(22) PCT Filed: Nov. 17, 2015
(86) PCT No.: PCT/CN2015/094849

§ 371 Date: Jun. 30, 2017

(30) Foreign Application Priority Data
Dec. 30, 2014 (CN) 201410850587.5

(51) Int. Cl. H04L 9/32; H04L 29/12; H04L 9/08; H04L 29/06; H04L 29/08

(52) U.S. Cl. CPC H04L 9/3268; H04L 63/18; H04L 67/02; H04L 63/0428; H04L 9/3226; H04L 9/0897; H04L 61/1552

(57) ABSTRACT

A method for loading website security information, and a browser apparatus. The method comprises: receiving a website address entered by a user via an address bar of a browser; performing security authentication of a digital certificate according to an authentication type of a network server corresponding to the website address, wherein the digital certificate is issued by a certificate authority (CA); and loading a security authentication identifier corresponding to the security authentication into the address bar of the browser after the security authentication has been passed. Authentication displaying is performed in the browser on the basis of the authentication of the digital certificate, and the security of a website is directly displayed.

### CROSS-REFERENCE TO RELATED APPLICATIONS

This application is the national stage of International Application No. PCT/CN2015/094849 filed Nov. 17, 2015, which claims the benefit of Chinese Patent Applications No. CN201410850587.5, filed Dec. 30, 2014, the entirety of which are incorporated herein by reference.

### FIELD OF TECHNOLOGY

The present invention relates to the field of Internet technologies, and in particular, to a method for loading website security information and a security browser apparatus.

### BACKGROUND

With the constant development of network technologies, a growing number of users acquire information by accessing webpages via a browser. The browser is a software that can display HTML (HyperText Mark-up Language) file contents of web servers or file systems and allow the users to interact with these files.

For example, shopping at shopping websites, watching videos at video websites, processing financial transactions at bank websites, and playing games at game websites, etc. The browsers may execute different access operations for network requests of different websites so as to access the webpages.

### SUMMARY

In view of the above problems, the present invention is proposed to provide a method for loading website security information and a corresponding secure browser apparatus to overcome or at least partially solve the above problems.

According to one aspect of the present invention, there is provided a method for loading website security information, which includes: receiving a website address entered by a user via an address bar of a browser; performing security authentication of a digital certificate according to an authentication type of a network server corresponding to the website address, wherein the digital certificate is issued by a certificate authority (CA); and loading a security authentication identifier corresponding to the security authentication into the address bar of the browser after the security authentication has been passed.

According to another aspect of the present invention, there is provided a secure browser apparatus, which includes: a receiving module, configured to receive a website address entered by a user via an address bar of a browser; an authentication module, configured to perform security authentication of a digital certificate according to an authentication type of a network server corresponding to the website address, wherein the digital certificate is issued by a certificate authority (CA); and an authentication identifier loading module, configured to load a security authentication identifier corresponding to the security authentication into the address bar of the browser after the security authentication has been passed.

According to another aspect of the present invention, there is provided a program, which includes a readable code, wherein when the readable code runs on a computing device, the computing device is caused to execute the method for loading website security information according to any one of the embodiments of the present invention.

According to another aspect of the present invention, there is provided a readable medium, in which the program of the embodiment of the present invention is stored.

When the browser accesses a website address in the address bar, the website address is transmitted based on HTTPS. Therefore, authentication of a digital certificate needs to be performed according to the website address, wherein the digital certificate is issued by a certificate authority (CA), and a security authentication identifier corresponding to the security authentication is loaded into the address bar of the browser after the security authentication has been passed. The website address transmitted via the HTTPS is subjected to display of authentication in the browser based on the authentication of the digital certificate, and the security of the website is directly displayed.

Described above is merely an overview of a technical solution of the present invention. In order to more apparently understand the technical means of the present invention to implement in accordance with the contents of specification, and to more readily understand above and other objectives, features and advantages of the present invention, specific embodiments of the present invention are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the present invention. Further, throughout the drawings, same elements are indicated by same reference numbers. In the drawings:

FIG. 1 illustrates a step flowchart of a method embodiment for loading website security information according to an embodiment of the present invention;

FIG. 2 illustrates an optional step flowchart of a method embodiment for loading website security information according to an embodiment of the present invention;

FIG. 3A, FIG. 3B and FIG. 3C illustrate schematic display diagrams of security authentication identifiers according to an embodiment of the present disclosure;

FIG. 4 illustrates a flowchart of a method for implementing a security browser according to an embodiment of the present invention;

FIG. 5 illustrates a schematic diagram of an agent mechanism of an encryption subprocess according to an embodiment of the present invention;

FIG. 6 illustrates a schematic diagram of a process of handshake between an encryption subprocess and a network server according to an embodiment of the present invention;

FIG. 7 illustrates a structural block diagram of a security browser apparatus embodiment according to an embodiment of the present invention;

FIG. 8 illustrates an optional structural block diagram of a security browser apparatus embodiment according to an embodiment of the present invention;

FIG. 9 illustrates a structural block diagram of an encryption subprocess according to an embodiment of the present invention;

FIG. 10 illustrates a structural block diagram of a main service process according to an embodiment of the present invention;

FIG. 11 illustrates a block diagram of a computing device for executing the method for loading website security information according to the present invention; and

FIG. 12 illustrates a memory unit for maintaining or carrying a program code for implementing the method for loading website security information according to the present invention.

### DESCRIPTION OF THE EMBODIMENTS

Exemplary embodiments of the present disclosure will be described in detail with reference to the accompanying figures hereinafter. Although the exemplary embodiments of the present invention are illustrated in the accompanying figures, it should be understood that the present invention may be embodied in many different forms and should not be construed as being limited to the embodiments set forth herein. Rather, these embodiments are provided so that this disclosure will be understood thoroughly and completely and will fully convey the scope of the present invention to those skilled in the art.

### Embodiment I

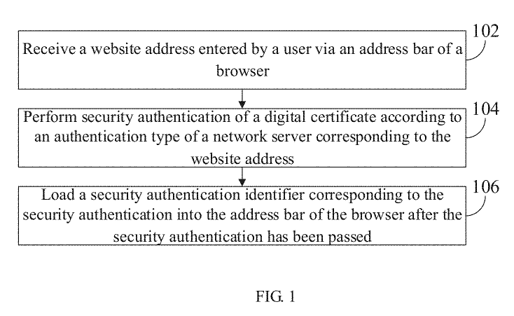

Referring to FIG. 1, which illustrates a step flowchart of a method embodiment for loading website security information according to an embodiment of the present invention, the method specifically may include following steps.

Step 102: receiving a website address entered by a user via an address bar of a browser.

When browsing a webpage in the browser, the user needs to enter the website address in the address bar to request to access the webpage corresponding to the website address. The website address received by the address bar in this embodiment may be directly entered by the user, or may be entered by searching and clicking a search result by the user, which is not limited by this embodiment.

In this embodiment, the website address is a uniform resource locator (URL). The URL is transmitted based on Hyper Text Transfer Protocol over Secure Socket Layer (HTTPS). The HTTPS is a Secure Sockets Layer (SSL) added under HTTP, whose security foundation is the SSL, which is a security protocol for providing security and data integrity for network communication.

Step 104: performing security authentication of a digital certificate according to an authentication type of a network server corresponding to the website address.

Security authentication of a digital certificate needs to be performed on the request initiated for the website address, namely a request for accessing the website based on a secure channel when accessing the network server corresponding to the website address. Based on different authentication types, differences exist in security authentication process of the digital certificate. In this embodiment, the authentication type includes a one-way authentication and a two-way authentication.

The certificate authority (CA) is an institution in charge of issuing, managing or abolishing the digital certificate. The role of the CA is to check the identity legitimacy of a certificate holder and sign and issue the certificate (to sign on the certificate) to prevent the certificate from forging or falsifying, and manage the certificate and a secret key. The digital certificate to be authenticated in the above security authentication process is issued by the CA.

The SSL protocol may be divided into two layers: an SSL record protocol, which is established on a reliable transmission protocol (such as TCP), providing high layer protocols with support of basic functions such as data encapsulation, compression or encryption; and an SSL handshake protocol, which is established on the SSL record protocol, used for performing identity authentication, negotiating an encryption algorithm and exchanging an encryption key between communication parties before the actual data transmission is started, namely performing security authentication of the digital certificate by means of a process of handshake.

Step 106: loading a security authentication identifier corresponding to the security authentication into the address bar of the browser after the security authentication has been passed.

After the security authentication of the digital certificate has been passed, it is determined that the network server and the website address to be accessed are secure, a page corresponding to the website address may be normally opened and a corresponding operation may be performed. At this moment, a security authentication identifier corresponding to the security authentication may be acquired, and then the security authentication identifier may be loaded in the address bar of the browser. The security authentication identifier is an identifier used for identifying an accessed website address to be secure. The security authentication identifier may be configured based on an authentication result of the certificate authority, that is, a security authentication identifier of a third party.

In this embodiment, an encryption subprocess may be started in the browser, and the encryption subprocess is used as an agent of a main service process. In this case, the Step 104 of certificate authentication and the Step 106 of loading a security authentication identifier are executed by means of the encryption subprocess.

In conclusion, when the browser accesses a website address in the address bar, the website address is transmitted based on HTTPS. Therefore, authentication of a digital certificate needs to be performed according to the website address, wherein the digital certificate is issued by a certificate authority (CA), and a security authentication identifier corresponding to the security authentication is loaded into the address bar of the browser after the security authentication has been passed. The website address transmitted via the HTTPS is subjected to display of authentication in the browser based on the authentication of the digital certificate, and the security of the website is directly displayed.

### Embodiment II

Based on the above embodiment, this embodiment elaborates a method for accessing a website address transmitted via HTTPS and loading authentication information.

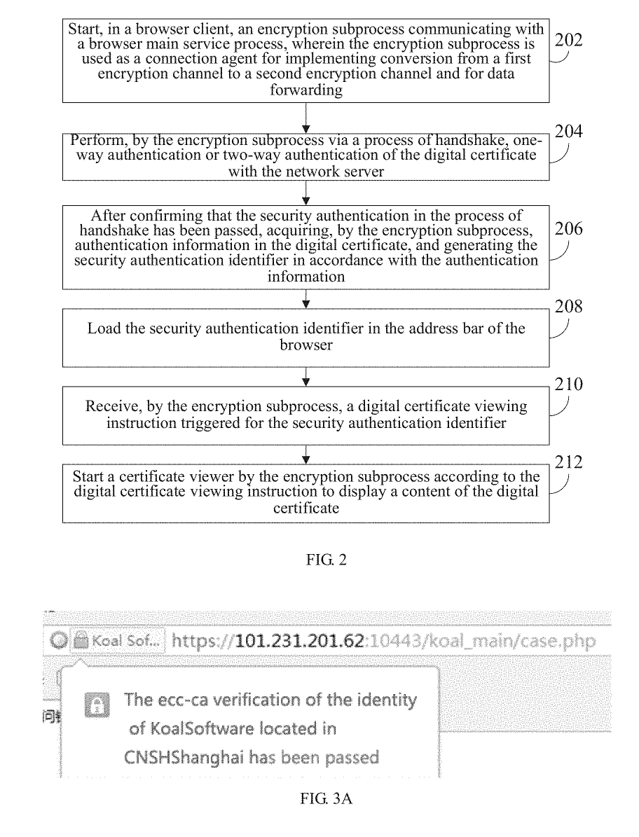

Referring to FIG. 2, which illustrates an optional step flowchart of a method embodiment for loading website security information according to an embodiment of the present invention, the method specifically may include following steps.

Step 202: starting, in a browser client, an encryption subprocess communicating with a main service process.

The encryption subprocess is used as a connection agent for implementing conversion from a first encryption channel to a second encryption channel and for data forwarding.

Step 204: performing, by the encryption subprocess via a process of handshake, one-way authentication or two-way authentication of the digital certificate with the network server.

1. One-Way Authentication

In this embodiment, the one-way authentication refers to performing an authentication on the network server of an accessed website to determine that the digital certificate of the accessed website is secure and effective. Therefore, the digital certificate is a site certificate of the accessed website.

The SSL mentioned in the above embodiment includes a handshake protocol. The security authentication of the site certificate in this embodiment is completed in the procedure of handshake between the browser client and the network server belonging to the website. The process of handshake at least includes following steps.

The browser client sends a client hello message (ClientHello) to the network server, wherein the client hello message includes first encrypted data of the browser client. The first encrypted data include a plurality of protocol version numbers, session ID, client side random number used as input in the key generation process, cipher suites and other attribute information. Each cipher suite includes a key exchange algorithm, an encryption algorithm and a check algorithm. The first encrypted data may be decided by the server and then fed back to the browser client.

The network server feeds back a server hello message (SeverHello) to the browser client, wherein the server hello message includes second encrypted data of the server client. The second encrypted data include: a protocol version number selected from the first encrypted data, that is, a protocol version number supported by the network server, a session ID, a cipher suite, and a server random number used as input in the key generation process. Therefore the above process is also referred to as an encrypted data negotiation process.

The network server sends a server certificate message (SeverCertificate) to the browser client. The server certificate message includes the site certificate of the network server, such as the signature certificate and the encryption certificate. Next, the browser client authenticates the site certificate of the network server. That is, the site certificate is authenticated using an asymmetric algorithm SM2 according to the above encrypted data negotiation result. As an elliptic curve public key cryptographic algorithm, the SM2 algorithm has a key length of 256 bits. The browser may load an encryption subprocess to execute the method for loading website security information in this embodiment to authenticate and access a website request based on HTTPS. The encryption subprocess may invoke the stored browser trusted root certificate list to verify the server certificate. The supported trusted root certificate is a PEM encoding mode, which simultaneously supports two certificate adding modes: 1) adding a trusted root certificate in a program; and 2) adding a trusted root certificate in a configuration file, which is encrypted and saved using data encryption standard (DES). To ensure security, import/export functions are not supported.

2. Two-Way Authentication

The step of performing, by the encryption subprocess via a process of handshake, two-way authentication of the digital certificate with the network server includes: performing, in sequence by the encryption subprocess via the process of handshake, following security authentication operations with the network server: encrypted data negotiation, certificate authentication, key exchange and signature authentication.

In this embodiment, the two-way authentication refers to authenticating the network server of the accessed website and the browser client to determine that the digital certificate of the accessed network server and the digital certificate loaded by the browser client are secure and effective. Therefore, the digital certificate includes the site certificate of the accessed website and the user certificate loaded by the browser client.

Similar to the one-way authentication process, the two-way authentication also is completed in the procedure of handshake between the browser client and the network server belonging to the website. The process of handshake at least includes following steps.

The browser client sends a client hello message (ClientHello) to the network server, and the network server feeds back a server hello message (SeverHello) to the browser client to negotiate on the encrypted data.

Next, the network server sends a server certificate message (SeverCertificate) to the browser client. Because the two-way authentication is needed, the network server sends, in sequence, a certificate authentication request message (SeverRequest), a server key exchange message (SeverKeyExchange) and a server hello done message (SeverHelloDone) to the browser client. The certificate authentication request message is used for indicating certificate authentication of the client.

Next, the browser client authenticates the site certificate of the network server using the asymmetric algorithm SM2. After the authentication is passed, the browser client sends a client certificate message (ClientCertificate) to the network server. The client certificate message includes a user certificate loaded by the browser client, so that the network server authenticates the user certificate loaded by the browser client based on the asymmetric algorithm SM2.

In the subsequent process of handshake, the browser client may also send, to the network server, a client key exchange message (ClientKeyExchange), a client hello done message (ClientHelloDone) and other handshake messages required for key exchange and signature authentication, which will be discussed in detail in Embodiment III.

In this embodiment, in the authentication process of the digital certificate, the asymmetric algorithm is adopted for authentication, that is, a sender encrypts data using a receiver's public key, and correspondingly the receiver decrypts the data using a private key of the receiver's own. The asymmetric algorithm of the certificate adopts the SM2 algorithm, using the signature certificate based on an ECDSA signature to implement identity authentication, and using the encrypted certificate based on ECDH to implement key negotiation.

In an optional embodiment of the present invention, the encryption subprocess pops up a certificate selection box when performing two-way authentication of the digital certificate, displays, in the certificate selection box, information of each user certificate loaded in a terminal where the browser is, and receives the user certificate selected by a user via the certificate selection box.

The method further includes: displaying a password entering message by the encryption subprocess, the password entering message being used for reminding a user to enter a protection password corresponding to the user certificate; receiving, by the encryption subprocess, the protection password entered by the user, verifying the protection password, and confirming the protection password to confirm that the user has a permission of using the user certificate.

In this embodiment, to ensure the security of the accessed website and the user, the CA issues different site certificates to different websites, and also issues different user certificates to different users of different websites. The digital certificate includes the public key of the site or the user, information of the site or the user, and digital signature, or the like.

In the two-way authentication process, the encryption subprocess may pop up a certificate selection box in the browser client, display, in the certificate selection box, information of each user certificate loaded in a terminal where the browser is, and receive the user certificate selected by a user via the certificate selection box. After the user selects the user certificate, the encryption subprocess displays a password entering message, wherein the password entry message is used for reminding the user to enter a protection password corresponding to the user certificate, for example, a personal identification number (PIN). The encryption subprocess receives the protection password entered by the user, and verifies the protection password, namely, verifies the user's identity through the protection password, to confirm whether the user has a permission of using the user certificate. In this way, after the entered protection password is correct, the protection password is confirmed to confirm that the user has a permission of using the user certificate. The user certificate and the protection password may be used as authentication data, in the authentication process of the user certificate, sent to the network server.

Optionally, the method further includes: the reminding, by the encryption subprocess via prompt information, the user to insert a security key storage hardware, the security key storage hardware storing the user certificate; invoking a driver program by the encryption subprocess to detect the security key storage hardware; and acquiring, by the encryption subprocess, information of the user certificate stored in the security key storage hardware after detecting the security key storage hardware.

When the browser client loads the user certificate, first the encryption subprocess reminds the user to insert a security key storage hardware through the prompt information. The security key storage hardware is the USB Key, which is a hardware device of a USB interface, with a built-in SCM or smart card chip, and having certain storage space. The security key storage hardware can store the user's private key and a digital certificate, and authentication of the user's identity is implemented using a built-in public key algorithm of the USB key. Since the user's private key is saved in a password lock, theoretically it cannot be read using any manner, thereby guaranteeing the security of user authentication.

After the user inserts the security key storage hardware, the driver program of the security key storage hardware is invoked to detect the security key storage hardware. After the security key storage hardware is detected, certificate information in the security key storage hardware is loaded via the certificate selection box, then the certificate information selected by the user is received, a protection password input window is popped up in the certificate selection box, and then a protection password inputted by the user is received.

The browser may automatically recognize two pieces of key information in a CSP registry entry relied on by the USBKey, namely SKFImagePath: a path of a designated SKF dynamic library; and TokenVidPid: character string format. The VendorID and the ProductID of the KEY device adopt a format similar to the in HKEY_LOCAL_MACHINE\SYSTEM\CurrentControlSet\Enum\USB, that is VID_XXXX&PID_XXXX.

The browser may complete the related operation by associating the vendor ID and the product ID of the USBKey device with a corresponding driver. The browser may neither store a pin cipher entered by the user nor store private key information in the USBKey. Operation flows of the USBKey are as follows: connecting the USBKey to the USBKey device; opening a corresponding application, wherein the application is selected by the user; opening a corresponding container, wherein the container is selected by the user; then entering a checking PIN code, reentering may be reminded in case of an verification error; then acquiring signature certificate information; and then acquiring encryption certificate information to verify the digital certificate. In the process of subsequent data interaction with the network server, encryption and decryption of the data are completed in the USBKey. After the website is accessed, the device is turned off and the access is disconnected.

In an optional embodiment of the present invention, a permission connection message returned by the network server is received, and a security connection channel is established for encrypted data transmission between the browser and the network server corresponding to the website, wherein the permission connection message is sent by the network server after the security authentication of the user certificate has been passed.

The network server returns the permission connection message after the certificate authentication is passed, and then the security connection channel is established for encrypted data transmission between the browser and the network server corresponding to the website. For transmitting data in the security connection channel, in this embodiment, the data are encrypted and decrypted using a symmetric algorithm (SM4 algorithm). The SM4 algorithm is a block cipher algorithm, which has a block length of 128 bits and a key length of 128 bits.

Step 206: after confirming that the security authentication in the process of handshake has been passed, acquiring, by the encryption subprocess, authentication information in the digital certificate, and generating the security authentication identifier in accordance with the authentication information.

Step 208: loading the security authentication identifier in the address bar of the browser, wherein the security authentication identifier comprises at least one of: an encryption algorithm employed for security authentication, a certificate authority (CA) issuing the digital certificate, and a security mechanism corresponding to the digital certificate.

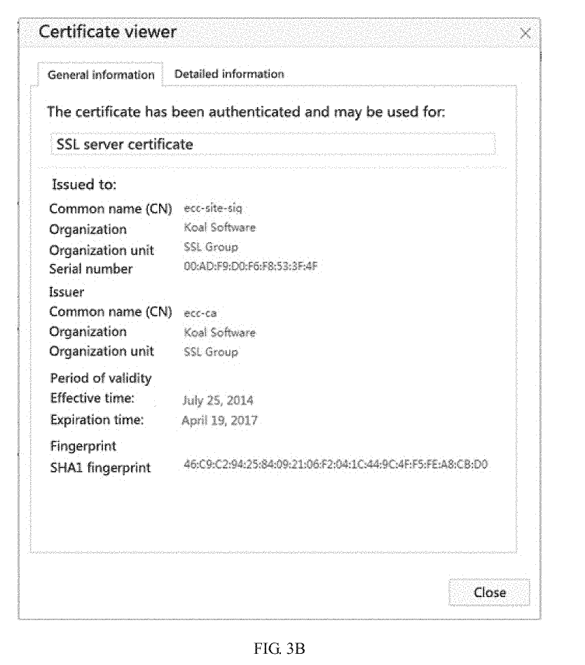

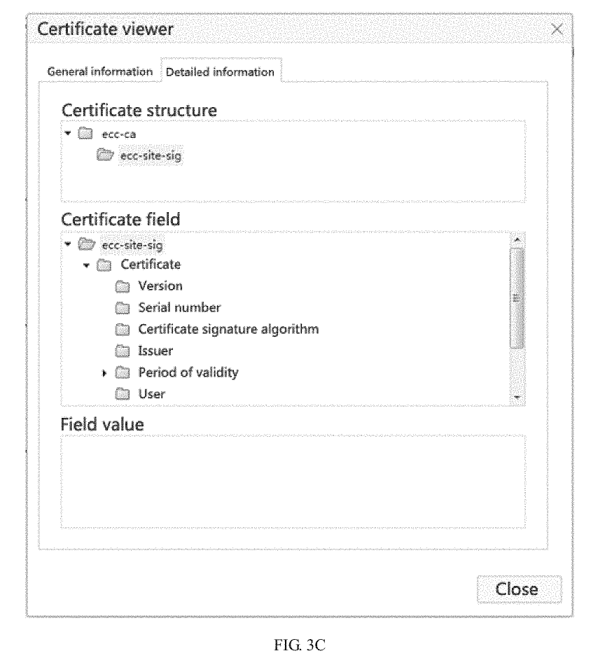

After the security authentication has been passed, a security authentication identifier corresponding to the security authentication may be acquired, wherein the security authentication identifier comprises at least one of: an encryption algorithm employed for the security authentication, a certificate authority (CA) issuing the digital certificate, and a security mechanism corresponding to the digital certificate. For example, the security authentication identifier is generated based on authentication by a third party of the CA. For example, the name of the CA is loaded in the security authentication identifier. Next, the security authentication identifier is loaded and displayed in the address bar of the browser, as shown in FIG. 3A. After the security authentication identifier is triggered, “ecc-ca verification of the identity of KoalSoftware located in CNSHShanghai has been passed” is displayed, and the certificate authority and the issuer of the certificate are displayed.

Step 210: receiving, by the encryption subprocess, a digital certificate viewing instruction triggered for the security authentication identifier.

Step 212: starting a certificate viewer by the encryption subprocess according to the digital certificate viewing instruction to display a content of the digital certificate.

When the user further views the security authentication identifier, the user may trigger the security authentication identifier to generate a digital certificate viewing instruction, and start the certificate viewer in accordance with the digital certificate viewing instruction to display the content of the digital certificate.

In an optional embodiment of the present invention, starting a certificate viewer according to the digital certificate viewing instruction to display a content of the digital certificate includes: starting the certificate viewer by the encryption subprocess according to the digital certificate viewing instruction; respectively setting up a general tab and a detailed tab in the certificate viewer; loading general information of the digital certificate in the general tab; and loading detailed information of the digital certificate in the detailed tab.

The certificate viewer is started according to the digital certificate viewing instruction. The certificate viewer is respectively provided with a general tab and a detailed tab in the certificate viewer. General information of the digital certificate is loaded in the general tab. As shown in FIG. 3B, the general information includes user information of a certain user to whom the digital certificate is issued, information of the issuer, period of validity and fingerprint. Detailed information of the digital certificate is loaded in the detailed tab. As shown in FIG. 3C, the detailed information includes Certificate Structure and Certificate Field. By clicking and triggering, the detailed information may be further viewed, so that different contents of the digital certificate may be viewed by selecting different tabs.

### Embodiment III

Based on the above embodiment, this embodiment expounds a method for implementing secure communication between a secure browser client and a network server based on agency of the encryption subprocess.

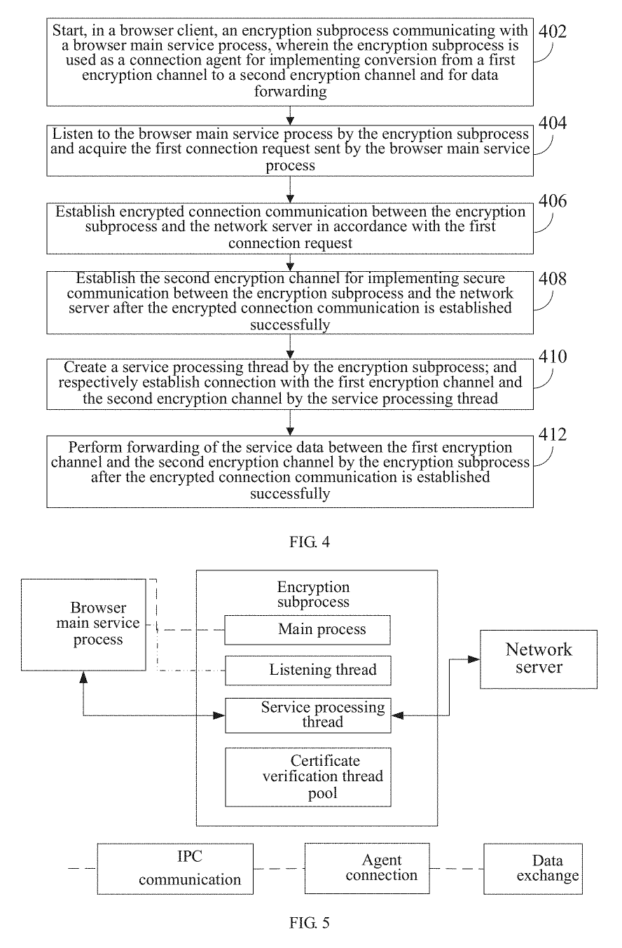

Referring to FIG. 4, which illustrates a step flowchart of an implementation method embodiment of a secure browser according to an embodiment of the present invention, the method may include following steps.

Step 402: starting, in a browser client, an encryption subprocess communicating with a browser main service process, wherein the encryption subprocess is used as a connection agent for implementing conversion from a first encryption channel to a second encryption channel and for data forwarding.

Some websites involving with financial services such as a bank website or Alipay website need to transmit encrypted data via an HTTP (HyperText Transfer Protocol) channel aiming at security. However, sometimes the browser main service process and the network server use different encryption protocols or algorithms, which causes a failure of direct communication, and thus access to a webpage of the network server is unavailable.

In this embodiment, there is provided a secure browser client, wherein the browser is further provided with an encryption subprocess communicating with the browser main service process. To enable the secure browser to be implemented, first the encryption subprocess communicating with the browser main service process needs to be started in the browser client. The main function of the encryption subprocess is to implement, as a connection agent, conversion from the first encryption channel to the second encryption channel and for data forwarding. That is, used as an agency of the main service process, the encryption subprocess not only can perform encrypted secure communication with the browser main service process, but also can perform encrypted secure communication with the network server. For example, service data of the browser main service process are sent to the encryption subprocess via the first encryption channel, and the encryption subprocess transmits the service data to the network server via the second encryption channel to implement data forwarding and communication of the two encrypted channels.

It is to be noted that, in general, the browser main service process may directly communicate with the network server. However, when communicating via the HTTP channel aiming at security, the encryption subprocess is started to serve as agent connection when the main service process cannot resolve the data information fed back by the network server, that is, the encryption subprocess serves as an agent between the main service process and the network server. The first encryption channel in this embodiment is a secure communication channel between the browser main service process and the encryption subprocess; and the second encryption channel is a secure communication channel between the encryption subprocess and the network server. Therefore, by converting the first encryption channel between the encryption subprocess and the main service process into the second encryption channel between the encryption subprocess and the network server, the encryption subprocess implements the connection agent between the main service process and the network server. Of course, the encryption subprocess may send, the service data sent by the main service process to the encryption subprocess via the first encryption channel, to the network server via the second encryption channel.

In this embodiment, the encryption subprocess communicating with the browser main service process may be automatically started by the browser. Specifically, when the browser main service process fails in communicating with the network server, the browser automatically starts the encryption subprocess, and the encryption subprocess receives a first connection request of the main service process, performs corresponding processing according to the service data contained in the first connection request, and forms the agent connection of the browser main service process.

The first encryption channel in this embodiment is a secure communication channel between the browser main service process and the encryption subprocess; and the second encryption channel is a secure communication channel between the encryption subprocess and the network server. Therefore, by converting the first encryption channel between the encryption subprocess and the main service process into the second encryption channel between the encryption subprocess and the network server, the encryption subprocess implements the connection agent between the main service process and the network server. Of course, the encryption subprocess may send, the service data sent by the main service process to the encryption subprocess via the first encryption channel, to the network server via the second encryption channel.

In this embodiment, the browser main service process and the encryption subprocess adopt an agent communication and inter-process communication (IPC), so that the encryption subprocess may serve as the connection agent to take charge of channel switching from the first encryption channel between the encryption subprocess and the browser main service process to the second encryption channel between the encryption subprocess and the network server and data forwarding, and the IPC is in charge of inter-process data transmission. In this embodiment, the encryption subprocess agent implementation mechanism is as shown in FIG. 5, which specifically may include following structures:

a main thread: configured to read various configurations, create a listening thread and a main service thread, and perform IPC communication with the browser main process;

the listening thread: configured to listen to a service port, and execute corresponding agent operations when a connection request exists in the main service process and is successfully accepted; and

a service processing thread: configured to respectively establish and maintain a corresponding encryption channel with the main service process and two ends of the network server, so as to serve as a bridge for data exchange at the two ends.

Step 404: listening to the browser main service process by the encryption subprocess and acquiring the first connection request sent by the browser main service process.

Listening to the browser main service process by the encryption subprocess specifically may be implemented in the following way: the encryption subprocess creates a listening thread; and the listening thread listens to the browser main service process via the service port. When listening to arrival of the first connection request, the listening thread receives the first connection request sent from the main service process. The first connection request sent from the browser main service process specifically may include service data. The encryption subprocess listens to the browser main service process to acquire the first connection request sent from the browser main service process in first time.

Step 406: establishing encrypted connection communication between the encryption subprocess and the network server in accordance with the first connection request.

In this embodiment, establishing encrypted connection communication between the encryption subprocess and the network server in accordance with the first connection request specifically may include following steps:

Substep I: performing encrypted data negotiation and certificate authentication in sequence between the encryption subprocess and the network server after determining that the first connection request is received successfully; and

Substep II: establishing encrypted connection communication between the browser client and the network server after the encrypted data negotiation is completed and the certificate authentication has been passed.

It is to be noted that the Substep I of performing encrypted data negotiation between the encryption subprocess and the network server specifically may be implemented in the following way: first, the encryption subprocess sends a client hello message to the network server, wherein the client hello message includes first encrypted data of the browser client, and the first encrypted data include a plurality of protocol version numbers. Second, the network server feeds a server hello message back to the encryption subprocess, wherein the server hello message includes second encrypted data of the server client, and the second encrypted data include a protocol version number selected from the first encrypted data. It should be noted that the client hello message and the server hello message are employed to determine the secure transmission capability of both parties, including a plurality of protocol version numbers, session IDs, cipher suites and the like, and generating and exchanging random numbers.

The client hello message (ClientHello) serves as the first message of the handshake protocol between the browser client and the network server. After sending the client hello message to the network server, the encryption subprocess waits for the server hello message returned by the network server. Structural definition of the client hello message:

1. Clien_vision denotes a protocol version used by the client in this session. For example, the protocol version number is 1.1.

2. Radom denotes random information generated by the client, including throughout and random numbers.

3. Session_id denotes a session ID used by the client in connection. The session_id is a variable length field, whose value is decided by the server. If there is no reusable session ID or desired negotiation security parameter, the field is empty, otherwise the client expects to reuse the session. This session ID may be a previous connection ID, a current connection ID, or other connection Ids in connection status. After the session ID is generated, the session ID should be consistently maintained until it is deleted due to timeout or the connection related to this session encounters a fatal error and thus is closed. When a session fails or is closed, all connections related to the session should be forcibly closed.

4. Cipher_suites may be a list of cipher suites supported by the client. The cipher suites should be prioritized by the client. The cipher suite of the highest priority should be placed at the top of the list. When the session ID field is not empty, this field should at least contain the cipher suites used by the to-be-reused session. Each cipher suite includes a key exchange algorithm, an encryption algorithm, and a check algorithm. The server will select, from the list of cipher suites, a cipher suite matching the server. When there is no matching cipher suite, a handshake failure alarm message should be returned and the connection should be closed.

5. Compression_methods may be a compression algorithm list supported by the client. The compression methods should be prioritized by the client, wherein the compression algorithm of the highest priority should be placed at the top of the list. The server will select, from the list of compression methods, a compression algorithm matching the server. The list must contain an empty compression algorithm so that the client and the server can always negotiate a consistent compression algorithm.

It is to be noted that when the server can find a matching cipher suite from the client hello message, the server sends the server hello message (Server Hello) as a response to the client hello message. When no matching cipher suite is found, the server will respond to a warning message.

It is to be noted that the Substep I of performing certificate authentication of the encryption subprocess and the network server in sequence specifically may include: performing one-way certificate authentication on the network server by the encryption subprocess; or performing two-way certificate authentication on the encryption subprocess and the network server.

In an optional example of this embodiment of the present invention, the encryption subprocess performs encryption operation in the process of two-way certificate authentication according to the hardware certificate carrier by driving and recognizing the security key storage hardware. For example, when the SSL connection establishing process needs two-way authentication, the encryption subprocess may remind the user to insert the security key storage hardware, namely the USBKey device. After the user insets the security key storage hardware, a certificate selection dialog box can be automatically recognized and popped up to remind the user to select the certificate. The encryption subprocess may automatically recognize two pieces of key information in a CSP registry entry relied on by the security key storage hardware, namely SKFImagePath: a path of a designated SKF dynamic library; and TokenVidPid: character string format. The VendorID and the ProductID of the KEY device adopt a format similar to the in HKEY_LOCAL_MACHINE\SYSTEM\CurrentControlSet\Enum\USB, that is VID_XXXX&PID_XXXX. The browser may complete the related operation by associating the vendor ID and the product ID of the USBKey device with a corresponding driver. The browser may neither store a pin cipher entered by the user nor store private key information in the USBKey. Specific flows are as below: first connecting to the USBKey device; then opening a corresponding application, which may be selected by the user; then opening a corresponding container, which may be selected by the user; then verifying a personal identification number (a PIN code), reentering may be reminded in case of an verification error; then acquiring signature certificate information; then acquiring encryption certificate information; and finally turning off the device and disconnecting.

1. One-Way Authentication

In an optional example of this embodiment of the present invention, performing one-way certificate authentication on the network server by the encryption subprocess specifically may be implemented in the following way: first, the encryption subprocess receives a server certificate message sent by the network server, wherein the server certificate message includes a site signature certificate of the network server; and second, the encryption subprocess performs authentication on the site signature certificate of the network server. In the following, a server certificate message is described. The network server needs to send a server certificate message to the client. The message always follows the server hello message closely. When the selected cipher suite is RSA, or ECC or ECDHE algorithm, the content of the server certificate message is a server ID and an IBC common parameter, used for negotiating an IBC public parameter between the client and the server. The relationship between the key exchange algorithm and the certificate key type is as shown in Table 1.

TABLE 1
Relationship between the key exchange algorithm and the
certificate key type

| Key exchange | |
|---|---|
| algorithm | Certificate key type |
| RSA | RSA public key, a public key in the encryption |
| | certificate must be used |
| IBC | Server ID and IBC common parameter |
| IBSDH | Server ID and IBC common parameter |
| ECC | ECC public key, a public key in the encryption |
| | certificate must be used |
| ECDHE | ECC public key, a public key in the encryption |
| | certificate must be used |

2. Two-Way Authentication

In an optional example of this embodiment of the present invention, performing two-way certificate authentication on the encryption subprocess and the network server specifically may be implemented in the following way:

1) the encryption subprocess receives a server certificate message sent by the network server, wherein the server certificate message includes a site signature certificate of the network server;

2) the encryption subprocess receives a certificate authentication request message sent by the network server, wherein the certificate authentication request message is used for indicating a certificate authentication performed on the client;

3) the encryption subprocess receives a server key exchange message sent by the network server, including a key exchange parameter;

4) the encryption subprocess receives a server hello done message sent by the network server;

5) the encryption subprocess performs authentication on the site signature certificate; and

6) after the authentication of the site signature certificate is passed, the encryption subprocess sends a client certificate message, which includes a signature certificate of the browser client, to the network server, so that the network server authenticates the signature certificate.

In an optional example of this embodiment of the present invention, the method further includes a step of key exchange: the encryption subprocess randomly generates a pre-master secret in accordance with the key exchange parameter, wherein the pre-master secret is obtained by performing encryption calculation using an encryption public key of the network server by means of an elliptic curve cryptography algorithm SM2. The encryption subprocess generates a client key exchange message using the pre-master secret, and sends the client key exchange message to the network server so that the network server acquires the pre-master secret.

In an optional example of this embodiment of the present invention, the method further includes a step of verifying a certificate signature, specifically including: the encryption subprocess acquiring a signature verification parameter calculated according to the site signature certificate, generates a client certificate verification message and sends the client certificate verification message to the network server. The encryption subprocess sends a client cipher specification change message to the network server to represent completion of negotiation of encrypted data. The encryption subprocess sends a client handshake finalization message to the network server. The encryption subprocess receives a server cipher specification change message sent by the network server to represent acception of negotiation of the encrypted data. The encryption subprocess receives a server handshake finalization message sent by the network server. It is to be noted that in each SSL handshake processing of the above SSL connection process, the server certificate is strictly authenticated.

In this embodiment, the above encrypted data negotiation, certificate authentication, key exchange and signature authentication are performed in the process of handshake between the encryption subprocess of the secure browser client and the network server. In this embodiment, the two-way authentication adopts a double certificate mechanism, the asymmetric algorithm of the certificate adopts the SM2 algorithm, using the signature certificate based on an ECDSA signature to implement identity authentication, and using the encrypted certificate based on ECDH to implement key negotiation. Data are encrypted using an SM4 algorithm, and the data are abstracted using an SM3 algorithm.

As an elliptic curve public key cryptographic algorithm, the SM2 algorithm has a key length of 256 bits. As a cryptographic hash algorithm, the SM3 algorithm has a key length of 128 bits. As a block cipher algorithm, the SM4 algorithm has a block length of 128 bits and a key length of 128 bits.

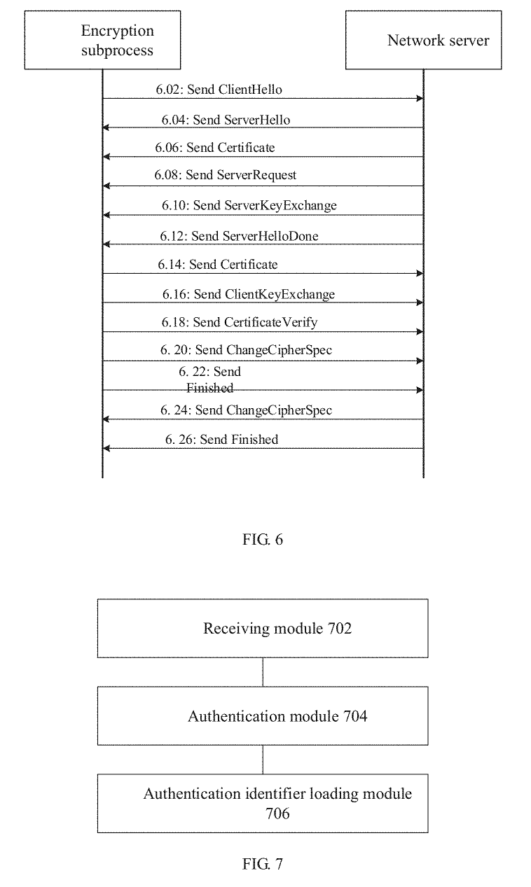

As shown in FIG. 6, the process of handshake between the encryption subprocess and the network server includes:

6.02: the encryption subprocess sends a client hello message (ClientHello) to the network server.

6.04: the network server sends a server hello message (SeverHello) to the encryption subprocess of the secure browser client.

When the network server finds a matching cipher suite from the ClientHello, the network server sends the SeverHello as response, or sends a warning message otherwise. In the SeverHello, Sever_vision represents a version number supported by the server, for example 1.1; Radom represents a random number generated by the server; session_id represents a session ID used by the server; cipher_suites represents a cipher suite selected by the server from the ClientHello; and compression_methods represents a compression algorithm selected by the server from the ClientHello.

6.06: the network server sends a server certificate message (SeverCertificate) to the encryption subprocess.

That is, contents of the SeverCertificate are the signature certificate and the encryption certificate, for example, the site signature certificate (X.509 sequence) of the server.

6.08: the network server sends a certificate authentication request message (SeverRequest) to the encryption subprocess.

By means of the SeverRequest, the client is requested to provide a certificate. Simultaneously, the authentication type (ECDSA) is pointed out.

6.10: the network server sends a server key exchange message (SeverKeyExchange) to the encryption subprocess.

The SeverKeyExchange is used for generating, by the client based on calculation, a 48-byte pre-master secret. The public key may be directly acquired from the encryption certificate of the server. For example, the client randomly generates a pre-master secret (pre_master_seceret), and performs ECDH operation using the public key of the server certificate.

6.12: the network server sends a server hello done message (SeverHelloDone) to the encryption subprocess.

The SeverHelloDone represents completion of the hello message stage in the process of handshake, and then waits for a response message from the client.

6.14: the encryption subprocess sends a client key exchange message (ClientCertificate) to the network server.

The ClientCertificate is the first message after the completion of the hello message stage, including, for example, the signature certificate (X.509 sequence) of the client.

6.16: the encryption subprocess sends a client key exchange message (ClientKeyExchange) to the network server.

The ClientKeyExchange is the encrypted pre-master secret of the public key of the network server.

6.18: the encryption subprocess sends a certificate verification message (CertificateVerify) to the network server.

The CertificateVerify is used for identifying whether the client is a legitimate holder. In this embodiment, after inserting the USBKey, the user is reminded to enter a protection password, wherein the protection password is carried in the message to verify whether the user is legitimate. For example, the client performs ESDSA signature on the abstract of the handshake information using an ECC private key of the signature certificate.

6.20: The encryption subprocess sends a client cipher specification change message (ChangeCipherSpec) to the network server.

That is, the ChangeCipherSpec is used for indicating to the server the algorithm and the completion of the key negotiation.

6.22: The encryption subprocess sends a client handshake finalization message (ClientFinished) to the network server.

In this embodiment, the encryption subprocess calculates the master_seceret using a key algorithm according to the random number of the client, the random number of the server and the pre_master_seceret, then calculates a real data encryption key using the random number and the master_seceret, and then abstracts all the handshake messages to cryptographically form the ClientFinished to be sent to the server.

6.24: The network server sends a server cipher specification change message (ChangeCipherSpec) to the encryption subprocess.

6.26: The network server sends a server handshake finalization message (Finished) to the encryption subprocess.

The server verifies the client certificate, and verifies the signature of the client using the signature certificate of the client. The server performs ECDH operation using its own encryption key to obtain the pre_master_seceret, calculates the master_seceret and the data encryption key using the same algorithm as used by the client, verifies correctness of the SeverFinished, and sends the SeverChangeCipherSpec to the client to denote recognition of the algorithm and the key negotiation.

Processes such as authentication and key negotiation between the browser client and the network server are completed through the above process of handshake, so that the encryption subprocess and the network server may respectively encrypt application data using the key calculated out through negotiation.

Step 408: establishing a second encryption channel for implementing secure communication between the encryption subprocess and the network server after the encrypted connection communication is established successfully.

The encryption subprocess performs encryption communication with the network server in the second encryption channel. Specifically, the service data used for communicating in the second encryption channel may be encrypted using a symmetric encryption algorithm SM4.

Step 410: creating a service processing thread by the encryption subprocess; and respectively establishing connection with the first encryption channel and the second encryption channel by the service processing thread.

A connection is respectively established for the service processing thread created by the encryption subprocess, the first encryption channel between the encryption subprocess and the main service process, and the second encryption channel between the encryption subprocess and the network server. The service processing thread specifically serves as a bridge between the main service process and the network server for data exchange at two ends.

Step 412: performing forwarding of the service data between the first encryption channel and the second encryption channel by the encryption subprocess after the encrypted connection communication is established successfully.

In this embodiment, performing forwarding of the service data between the first encryption channel and the second encryption channel by the encryption subprocess specifically may be implemented through the following way: the service processing thread receives, via the first encryption channel, first service data sent by the browser main service process. The service processing thread decrypts the first service data using a first symmetric algorithm to acquire original service data. The service processing thread encrypts the original service data using a second symmetric algorithm to acquire second service data. The service processing thread sends the second service data to the network server via the second encryption channel. It is to be noted that the above process is a process of respectively performing data conversion on two channels by the encryption subprocess in the process of data communication.

In an optional example of this embodiment of the present invention, the encryption subprocess and the browser main service process establish encrypted connection communication through a process of handshake, and establish a first encryption channel for implementing secure communication between the browser main service process and the encryption subprocess after the encrypted connection communication is established successfully. In the process of handshake, two-way certificate authentication and key exchange between the encryption subprocess and the browser main service process are performed using a first asymmetric algorithm, and certificate authentication is performed. A symmetric key is generated in the process of the key exchange. It is to be noted that the first asymmetric algorithm specifically may be an RSA algorithm.

In an optional example of this embodiment of the present invention, the method for implementing a security browser further includes: obtaining a second connection request by encrypting the first connection request by the service processing thread using the second symmetric algorithm: sending the second connection request to the network server by the service processing thread; receiving, by the service processing thread, a second connection response fed back by the network server based on the second connection request; and obtaining a first connection response by decrypting the second connection response by the second connection request using the second symmetric algorithm, and feeding back the first connection response to the browser main service process.

It is to be noted that specific flows of the service processing thread are as below: (1) receiving agent data, specifically receiving http request data of agent connection. (2) Performing SSL connection with the network server, which specifically includes establishing the SSL connection, SSL protocol negotiation, algorithm negotiation, and client certificate verification (CRL check or OCSP authentication). (3) Interacting with a web server. Specifically, the agent connection http request data are sent to the web server via a commercial cryptography SSL channel to acquire http response of the web server. (4) Sending the data returned by the network server to the agent connection. Specifically, the http response of the network server is forwarded to the agent connection. (5) Closing connection The connection is closed when an error occurs in the service processing flow, meanwhile the error page is returned to the agent connection. It is to be noted that the second symmetric algorithm specifically may be a commercial cryptography algorithm.

It is to be noted that using the SSL security technology to solve the problem of network application identity authentication and data confidentiality is widely accepted. SSL modules are built in mainstream browsers and web servers, and professional SSL hardware products are widely used. However, the current SSL products also have certain limitations:

(1) The current SSL products generally adopt a single certificate mechanism. However, the double certificate mechanism is the mainstream mode in the system construction of the current public key infrastructure (PM). In this embodiment, the signature certificate is employed to perform identity authentication, and the encryption certificate is used for key exchange and protection, which gives play to advantages of the asymmetric key in the PM technology.

(2) Symmetric algorithms disclosed abroad are universally adopted in the current SSL products, which does not meet confidentiality requirements, and has a certain risk. In this embodiment, the cryptographic product symmetric algorithm adopts the SM1 algorithm or the SM4 algorithm.

(3) The current certificate asymmetric algorithm adopts the RSA algorithm. However, as a public key cryptography having higher security and higher efficiency than the RSA, the elliptic curve cryptography (ECC) used in this embodiment has important cryptographic functions such as encryption/decryption, digital signature and key negotiation, may securely and conveniently meet various important information security requirements in information network, such as user identity recognition, electronic information identification and confidential transmission, serves as a core technology in the field of information security, have been gradually adopted by many international and national standards organizations (IEEE P1363, ANSI X9, ISO/IEC and IETF, etc.) as a public key cryptography standard, and will become one of mainstream cryptographic techniques used in the information security industry. The above ECC (ECDSA+ECDH) algorithm may be named as SM2.

This embodiment provides a method for implementing a security browser, which may implement network security browsers conforming to the PM mechanism and cryptographic product management policies, and play a positive role in promoting standardized management of domestic security products and rapid growth of network applications.

In this embodiment, first, an encryption subprocess communicating with a browser main service process is started in the browser client, wherein the encryption subprocess is used as a connection agent for implementing conversion from a first encryption channel to a second encryption channel and for data forwarding. Next, the encryption subprocess listens to the browser main service process and acquires a first connection request sent by the browser main service process. Next, encrypted connection communication is established between the encryption subprocess and the network server in accordance with the first connection request. Finally, after the encrypted connection communication is established successfully, the encryption subprocess performs forwarding of the service data between the first encryption channel and the second encryption channel, wherein the first encryption channel is a secure communication channel between the browser main service process and the encryption subprocess; and the second encryption channel is a secure communication channel between the encryption subprocess and the network server. In this embodiment, the encryption subprocess may serve as an agent to implement conversion from the first encryption channel to the second encryption channel and data forwarding, so that a secure encryption channel is successfully established between the browser main service process and the network server, thereby guaranteeing secure transmission of service data, reducing the risk of leakage of the service data, and improving security and reliability of transmission of the service data. Moreover, in this embodiment, the above functions are implemented through a browser. Therefore, in the process of using the browser client by the user, the browser client may automatically start the secure channel established, by the encryption subprocess, between the main service process and the network server to implement the above functions. In this way, the security and reliability of data transfer between the browser and the network server, and the secure browser can be implemented.

It should be explained that, for a brief description, method embodiments are describe as a combination of a series of motions. However, those skilled in the art should know that the embodiments of the present invention are not limited by sequences of the motions described. This is because some steps may be performed by using other sequences or be performed simultaneously in accordance with the embodiments of the present invention. In addition, those skilled in the art should also learn that the embodiments described in the specification are preferred embodiments, and involved motions are not necessary for the embodiments of the present invention.

### Embodiment IV

Based on the foregoing embodiments, this embodiment further discloses a security browser apparatus.

Referring to FIG. 7, which illustrates a structural block diagram of a security browser apparatus embodiment according to an embodiment of the present invention, the security browser apparatus specifically may include following modules:

a receiving module 702, configured to receive a website address entered by a user via an address bar of a browser;

an authentication module 704, configured to perform security authentication of a digital certificate according to an authentication type of a network server corresponding to the website address, wherein the digital certificate is issued by a certificate authority CA; and

an authentication identifier loading module 706, configured to load a security authentication identifier corresponding to the security authentication into the address bar of the browser after the security authentication has been passed.

In conclusion, when the browser accesses a website address in the address bar, the website address is transmitted based on HTTPS. Therefore, authentication of a digital certificate needs to be performed according to the website address, wherein the digital certificate is issued by a certificate authority (CA), and a security authentication identifier corresponding to the security authentication is loaded into the address bar of the browser after the security authentication has been passed. The website address transmitted via the HTTPS is subjected to display of authentication in the browser based on the authentication of the digital certificate, and the security of the website is directly displayed.

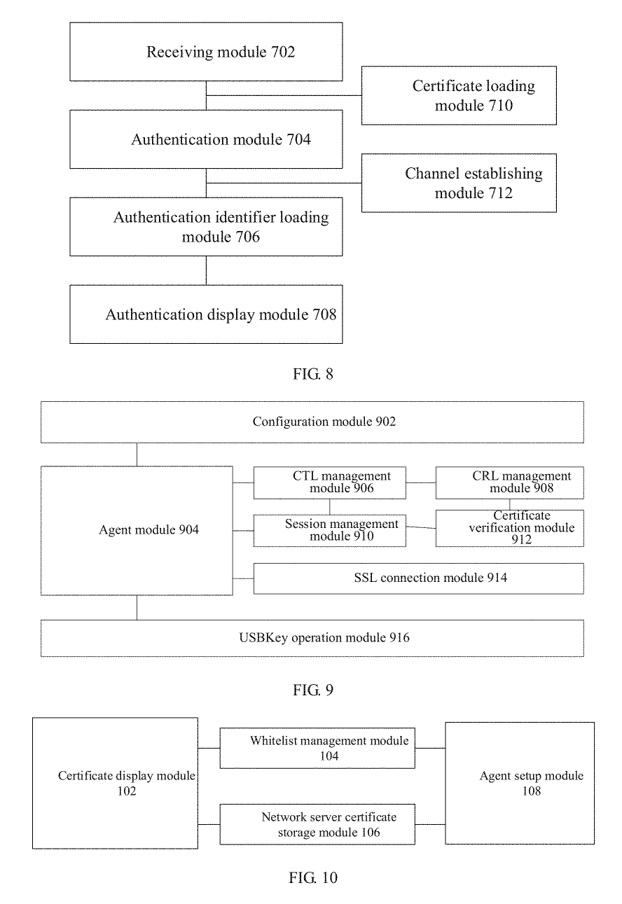

Referring to FIG. 8, which illustrates an optional structural block diagram of a security browser apparatus embodiment according to an embodiment of the present invention, the security browser apparatus specifically may include following modules.

In an optional embodiment of the present invention, the authentication type includes a one-way authentication, and the digital certificate includes a site certificate. The authentication module 704 is configured to acquire a site certificate sent by the network server, and perform security authentication of the site certificate on the network server using an asymmetric algorithm.

In another optional embodiment of the present invention, the authentication type includes a two-way authentication, and the digital certificate includes a site certificate and a user certificate. The authentication module 704 is configured to acquire a site certificate sent by the network server, perform security authentication of the site certificate on the network server using an asymmetric algorithm, and send the user certificate loaded in the browser to the network server after the security authentication of the network server has been passed to perform security authentication on the user certificate of the browser.

The security browser apparatus further includes: an authentication display module 708, configured to receive a digital certificate viewing instruction triggered for the security authentication identifier, and start a certificate viewer according to the digital certificate viewing instruction to display a content of the digital certificate.

The authentication display module 708 is configured to start the certificate viewer according to the digital certificate viewing instruction, respectively set up a general tab and a detailed tab in the certificate viewer, load general information of the digital certificate in the general tab, and load detailed information of the digital certificate in the detailed tab.

A certificate loading module 710, configured to pop up a certificate selection box, receive a certificate selected by a user and a protection password entered by the user via the certificate selection box, and generate the user certificate using the certificate selected by the user and the protection password entered by the user.

A channel establishing module 712, configured to receive a permission connection message returned by the network server, and establish a security connection channel between the browser and the network server corresponding to the website for encrypted data transmission, wherein the permission connection message is sent by the network server after the security authentication of the user certificate has been passed.

The certificate loading module 710 is further configured to remind, by popping up the certificate selection box, the user to insert a security key storage hardware, invoke, after the user inserts the security key storage hardware, a driver program of the security key storage hardware to load certificate information in the security key storage hardware via the certificate selection box, receive the certificate information selected by the user via the certificate selection box, pop up a protection password input window in the certificate selection box, and receive a protection password inputted by the user via the protection password input window.

In an optional example of this embodiment of the present invention, the secure browser apparatus includes: a browser main service process module, configured to start, in a browser client, an encryption subprocess module of an encryption subprocess communicating with a browser main service process, wherein the encryption subprocess is used as a connection agent for implementing conversion from a first encryption channel to a second encryption channel and for data forwarding.

The encryption subprocess module includes an agent submodule and a secure connection submodule. The agent submodule is configured to listen the browser main service process, acquire a first connection request sent by the browser main service process, and forward the encryption subprocess execution service data between the first encryption channel and the second encryption channel after the encrypted connection communication is established successfully. The secure connection submodule is configured to establish encrypted connection communication between the encryption subprocess and the network server in accordance with the first connection request. The first encryption channel is a secure communication channel between the browser main service process and the encryption subprocess; and the second encryption channel is a secure communication channel between the encryption subprocess and the network server.

The agent submodule is configured to create a listening thread for the encryption subprocess. The listening thread is configured to listen to the browser main service process via a service port.

In an optional example of this embodiment of the present invention, the secure connection submodule is configured to perform encrypted data negotiation and certificate authentication in sequence between the encryption subprocess and the network server after determining that the first connection request is received successfully, and establish encrypted connection communication between the browser client and the network server after the encrypted data negotiation is completed and the certificate authentication has been passed.

In an optional example of this embodiment of the present invention, the secure connection submodule is configured to send a client hello message to the network server by the encryption subprocess. The client hello message includes first encrypted data of the browser client, and the first encrypted data include a plurality of protocol version numbers. The network server feeds a server hello message back to the encryption subprocess, wherein the server hello message includes second encrypted data of the server client, and the second encrypted data include a protocol version number selected from the first encrypted data.

In an optional example of this embodiment of the present invention, the secure connection submodule is configured to perform one-way certificate authentication on the network server, or perform two-way certificate authentication on the encryption subprocess and the network server.

In an optional example of this embodiment of the present invention, the agent submodule is further configured to create a service processing thread, wherein the service processing thread is configured to respectively establish connection with the first encryption channel and the second encryption channel.

In an optional example of this embodiment of the present invention, the agent submodule is configured to receive, using the service processing thread via the first encryption channel, first service data sent by the browser main service process. The service processing thread decrypts the first service data using a first symmetric algorithm to acquire original service data. The service processing thread encrypts the original service data using a second symmetric algorithm to acquire second service data. The service processing thread sends the second service data to the network server via the second encryption channel.

In an optional example of this embodiment of the present invention, the secure connection submodule is configured to receive a server certificate message sent by the network server. The server certificate message includes a site signature certificate of the network server. The encryption subprocess performs authentication on the site signature certificate of the network server.

In an optional example of this embodiment of the present invention, the secure connection submodule is configured to receive, by the encryption subprocess, a server certificate message sent by the network server. The server certificate message includes a site signature certificate of the network server. The encryption subprocess receives a certificate authentication request message sent by the network server. The certificate authentication request message is configured to indicate a certificate authentication of the client. The encryption subprocess receives a server key exchange message sent by the network server, including a key exchange parameter. The encryption subprocess receives a server hello done message sent by the network server. The encryption subprocess authenticates the site signature certificate. After authentication of the site signature certificate is passed, the encryption subprocess sends a client certificate message to the network server, wherein the client certificate message includes a signature certificate of the browser client, so that the network server authenticates the signature certificate.

In an optional example of this embodiment of the present invention, the secure connection submodule is further configured to randomly generate a pre-master secret in accordance with the key exchange parameter, wherein the pre-master secret is obtained by performing encryption calculation using an encryption public key of the network server by means of an elliptic curve cryptography algorithm SM2. The encryption subprocess generates a client key exchange message using the pre-master secret, and sends the client key exchange message to the network server so that the network server acquires the pre-master secret.

In an optional example of this embodiment of the present invention, the secure connection submodule is further configured to acquire a signature verification parameter calculated according to the site signature certificate, generate a client certificate verification message and send the client certificate verification message to the network server. The encryption subprocess sends a client cipher specification change message to the network server to represent completion of negotiation of encrypted data. The encryption subprocess sends a client handshake finalization message to the network server. The encryption subprocess receives a server cipher specification change message sent by the network server to represent acception of negotiation of the encrypted data. The encryption subprocess receives a server handshake finalization message sent by the network server.

In an optional example of this embodiment of the present invention, the secure connection submodule is further configured to establish a second encryption channel for implementing secure communication between the encryption subprocess and the network server after the encrypted connection communication is established successfully.

In an optional example of this embodiment of the present invention, the agent submodule is further configured to establish encrypted connection communication through a process of handshake using the encryption subprocess and the browser main service process, and establish a first encryption channel for implementing secure communication between the browser main service process and the encryption subprocess after the encrypted connection communication is established successfully. In the process of handshake, two-way certificate authentication and key exchange between the encryption subprocess and the browser main service process are performed using a first asymmetric algorithm, and certificate authentication is performed. A symmetric key is generated in the process of the key exchange.

In an optional example of this embodiment of the present invention, the agent submodule is further configured to obtain a second connection request by encrypting the first connection request by the service processing thread using the second symmetric algorithm. The service processing thread sends the second connection request to the network server. The service processing thread receives a second connection response fed back by the network server based on the second connection request. The second connection request obtains a first connection response by decrypting the second connection response using the second symmetric algorithm, and the first connection response is fed back to the browser main service process.

It is to be noted that the encryption subprocess may be understood by referring to the structural block diagram of the encryption subprocess as shown in FIG. 9. As shown in FIG. 9, the encryption subprocess includes: a configuration module 902, an agent module 904, a CTL management module 906, a CRL management module 908, a Session management module 910, a certificate verification module 912, an SSL connection module 914, and a USBKey operation module 916. The agent module accepts connection of the browser main service process, and performs corresponding processing according to the type of the connection of the browser main service process to form a connection agent of the browser main service process. The CTL module is configured to manage a trusted root certificate list. The CRL management module is configured to acquire a CRL list and manage a local CRL list. The Session management module is configured to manage session connection between an agent process and a web server. The SSL connection module is in charge of establishing a secure connection with the web server. The USBKey operation module is in charge of operating a USB Key device. The configuration module is in charge of reading and storing related configuration of the client.

The working principle of the CTL management module 906 is as below: what is described by the CTL is the trusted root certificate list of the browser, used for verifying a server certificate. In the secure browser client, the supported trusted root certificate is a PEM encoding mode, which simultaneously supports two certificate adding modes: 1) adding a trusted root certificate in a program; and 2) adding a trusted root certificate in a configuration file, which is encrypted and saved using data encryption standard (DES). The CTL may be configured to not support import/export functions.

The working principle of the CRL management module 908 is as below: what is described by the CRL is a certificate revocation list of the certificate authority (CA), which in essence is a certificate serial number, represented by Integer encoded by ASN.1. An extension (OID being 2.5.29.31) of the X509v3 certificate is configured to designate a CRL publishing point of this certificate. The secure browser apparatus in this embodiment locally caches the CRL and performs first level index on the CRL according to the CA. Steps of the verification operation on the CRL are as below: (1) acquiring an Issuer item in the certificate and locating a corresponding CA node, wherein when the Issuer item is absent or no corresponding CA item can be found, the certificate is considered to be an illegal certificate; and (2) searching for all CRL items under the CA using a dichotomy.

For the Session management module 910, the SSL connection needs to add four handshakes on the basis of three TCP handshakes, and the connection establishing process is time-consuming. Therefore, saving Session and reusing a previous connection may effectively optimize a connection performance. After one SSL connection is established, the secure browser apparatus in this embodiment may establish a memory index from host+port to session, and the previous session may be reused in subsequent operations, for example, the period of validity of the session is one hour. The previous session may be emptied after the browser is closed or the USBKey device is plugged out.

For the certificate verification module 912, when the SSL connection establishing process needs two-way authentication, the encryption subprocess may remind the user to insert a security key storage hardware such as the USBKey device. After the user insets the security key storage hardware, a certificate selection dialog box can be automatically recognized and popped up to remind the user to select the certificate. The encryption subprocess may automatically recognize two pieces of key information in a CSP registry entry relied on by the security key storage hardware, namely SKFImagePath: a path of a designated SKF dynamic library; and TokenVidPid: character string format. The VendorID and the ProductID of the KEY device adopt a format similar to the in HKEY_LOCAL_MACHINE\SYSTEM\CurrentControlSet\Enum\USB, that is VID_XXXX&PID_XXXX. The browser may complete the related operation by associating the vendor ID and the product ID of the USBKey device with a corresponding driver. The browser may neither store a pin cipher entered by the user nor store private key information in the USBKey. Specific flows are as below: first connecting to the USBKey device; then opening a corresponding application, which may be selected by the user; then opening a corresponding container, which may be selected by the user; then verifying a personal identification number (a PIN code), reentering may be reminded in case of a verification error; then acquiring signature certificate information; then acquiring encryption certificate information; and finally turning off the device and disconnecting.

In this embodiment, for the certificate verification process of the above method embodiments, certificate verification of the server happens in the process of the handshake protocol, after receiving the ServerHelloDone message and before sending a certificate message by the browser. The certificate verification is mainly for the purpose of ensuring the reasonability of the server. The verification process is dependent on the CTL module and the CRL module, and the specific process proceeds in a subprocess certificate verification thread pool. Inspection steps are as below: initializing the trusted root certificate list; inspecting whether it is a self-signed certificate; inspecting certificate extension information; inspecting certificate trust relationship; inspecting a CRL list; inspecting certificate signature; inspecting time validity of the certificate; and inspecting whether the certificate is in the blacklist.

It is to be noted that the main service process may be understood by referring to the structural block diagram of the main service process as shown in FIG. 10. As shown in FIG. 10, the main service process includes: a certificate display module 1002, a whitelist management module 1004, a network server certificate storage module 1006 and an agent setup module 1008. The certificate display module 1002 is in charge of displaying a digital certificate. The whitelist management module 1004 is in charge of managing a web server list supporting an encryption algorithm of this embodiment. The network server certificate storage module 1006 is configured to store a certificate in charge of managing the network server. The agent setup module 1008 is configured to set up an agent in charge of setting up the encryption subprocess.

Device embodiments are basically similar to method embodiments, so description of device embodiments is relatively simple. Please see method embodiments which may serve as reference.

Algorithm and display provided herein are not inherently related to a particular computer, virtual system or other equipment. Various general systems may also be used with the teaching based on the present invention. According to the above description, the required structure for constructing such a system is obvious. In addition, the present invention is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

Similarly, it should be understood that, in order to simplify the present invention and to facilitate the understanding of one or more of various aspects thereof, in the above description of the exemplary embodiments of the present invention, various features of the present invention may sometimes be grouped together into a single embodiment, accompanying figure or description thereof. However, the method of this disclosure should not be constructed as follows: the present invention for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the present invention.

It should be understood by those skilled in the art that modules of the device in the embodiments can be adaptively modified and arranged in one or more devices different from the embodiment. Modules, units or components in the embodiment can be combined into one module, unit or component, and also can be divided into more sub-modules, sub-units or sub-components. Except that at least some of features and/or processes or units are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the present invention and forms the different embodiment. For example, in the claims, any one of the embodiments for which the protection is sought can be used in any combination manner.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the method, apparatus and device for loading website security information according to the embodiments of the present invention. The present invention may further be implemented as equipment or device program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

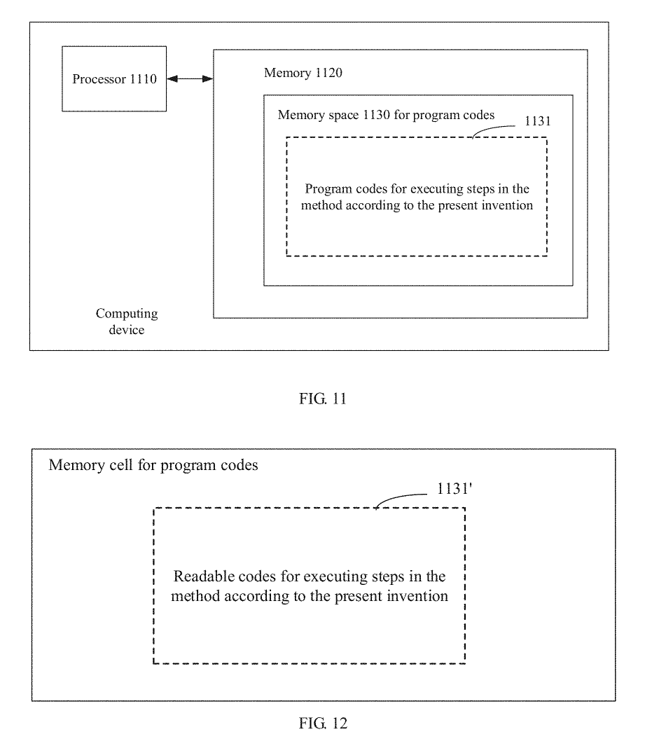

For example, FIG. 11 illustrates a computing device that may implement to generate a function menu according to the present invention. Traditionally, the computing device includes a processor 1110 and a program product or a readable medium in form of a memory 1120. The memory 1120 could be electronic memories such as flash memory, EEPROM (Electrically Erasable Programmable Read—Only Memory), EPROM or ROM. The memory 1120 has a memory space 1130 for executing program codes 1131 of any steps in the above methods. For example, the memory space 1130 for program codes may include respective program codes 1131 for implementing the respective steps in the method as mentioned above. These program codes may be read from and/or be written into one or more program products. These program products include program code carriers such as memory card. These program products are usually the portable or stable memory cells as shown in reference FIG. 12. The memory cells may be provided with memory sections, memory spaces, etc., similar to the memory 1120 of the computing device as shown in FIG. 11. The program codes may be compressed for example in an appropriate form. Usually, the memory cell includes readable codes 1131′ which can be read for example by processors 1110. When these codes are operated on the computing device, the computing device may execute respective steps in the method as described above.

It should be noted that the above-described embodiments are intended to illustrate but not to limit the present invention, and alternative embodiments can be devised by a person skilled in the art without departing from the scope of claims as appended. In the claims, no reference mark between round brackets shall impose restriction on the claims. The word “include/comprise” does not exclude a component or step not listed in the claims. The wording “a” or “an” in front of an element does not exclude the presence of a plurality of such elements. The present invention may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be construed as naming.

1. A method for loading website security information, comprising:
receiving a website address entered by a user via an address bar of a browser;
performing security authentication of a digital certificate according to an authentication type of a network server corresponding to the website address, wherein the digital certificate is issued by a certificate authority CA; and
loading a security authentication identifier corresponding to the security authentication into the address bar of the browser after the security authentication has been passed.

2. The method according to claim 1, further comprising:
starting, in a browser client, an encryption subprocess communicating with a main service process, wherein the encryption subprocess is used as a connection agent for implementing conversion from a first encryption channel to a second encryption channel and for data forwarding.

3. The method according to claim 2, wherein performing security authentication of a digital certificate according to an authentication type of a network server corresponding to the website address comprises:
performing, by the encryption subprocess via a process of handshake, one-way authentication or two-way authentication of the digital certificate with the network server.

4. (canceled)

5. The method according to claim 3, wherein loading a security authentication identifier corresponding to the security authentication into the address bar of the browser after the security authentication has been passed comprises:
after confirming that the security authentication in the process of handshake has been passed, acquiring, by the encryption subprocess, authentication information in the digital certificate, and generating the security authentication identifier in accordance with the authentication information; and
loading the security authentication identifier in the address bar of the browser, wherein the security authentication identifier comprises at least one of: an encryption algorithm employed for security authentication, a certificate authority CA issuing the digital certificate, and a security mechanism corresponding to the digital certificate.

6. The method according to claim 2, further comprising:
receiving, by the encryption subprocess, a digital certificate viewing instruction triggered for the security authentication identifier; and
starting a certificate viewer by the encryption subprocess according to the digital certificate viewing instruction to display a content of the digital certificate.

7. The method according to claim 6, wherein starting a certificate viewer by the encryption subprocess according to the digital certificate viewing instruction to display a content of the digital certificate comprises:
starting the certificate viewer by the encryption subprocess according to the digital certificate viewing instruction;
respectively setting up a general tab and a detailed tab in the certificate viewer by the encryption subprocess;
loading general information of the digital certificate in the general tab by the encryption subprocess; and
loading detailed information of the digital certificate in the detailed tab by the encryption subprocess.

8. The method according to claim 3, further comprising:
when performing two-way authentication of the digital certificate, popping up a certificate selection box by the encryption subprocess, and displaying, in the certificate selection box, information of each user certificate loaded in a terminal where the browser is; and
receiving the user certificate selected by a user via the certificate selection box.

9. The method according to claim 2, further comprising:
displaying a password entering message by the encryption subprocess, the password entering message being used for reminding a user to enter a protection password corresponding to the user certificate; and
receiving, by the encryption subprocess, the protection password entered by the user, verifying the protection password, and confirming the protection password to confirm that the user has a permission of using the user certificate.

10. (canceled)

11. The method according to claim 8, further comprising:
reminding, by the encryption subprocess via prompt information, the user to insert a security key storage hardware, the security key storage hardware storing the user certificate;
invoking a driver program by the encryption subprocess to detect the security key storage hardware; and
acquiring, by the encryption subprocess, information of the user certificate stored in the security key storage hardware after detecting the security key storage hardware.

12. A security browser apparatus, comprising:
a memory having instructions stored thereon;
a processor configured to execute the instructions to perform operations for loading website security information, the operations comprising:
receiving a website address entered by a user via an address bar of a browser;
performing security authentication of a digital certificate according to an authentication type of a network server corresponding to the website address, wherein the digital certificate is issued by a certificate authority CA; and
loading a security authentication identifier corresponding to the security authentication into the address bar of the browser after the security authentication has been passed.

13. The apparatus according to claim 12, wherein the operations further comprise:
starting, in a browser client, an encryption subprocess communicating with a main service process, wherein the encryption subprocess is used as a connection agent for implementing conversion from a first encryption channel to a second encryption channel and for data forwarding.

14. The apparatus according to claim 13, wherein the operation of performing security authentication of a digital certificate according to an authentication type of a network server corresponding to the website address comprises:
performing, using the encryption subprocess via a process of handshake, one-way authentication or two-way authentication of the digital certificate with the network server.

15. (canceled)

16. The apparatus according to claim 14, wherein the operation of loading a security authentication identifier corresponding to the security authentication into the address bar of the browser after the security authentication has been passed comprises:
acquiring authentication information in the digital certificate using the encryption subprocess and generate the security authentication identifier in accordance with the authentication information after confirming that the security authentication in the process of handshake has been passed, and loading the security authentication identifier in the address bar of the browser, wherein the security authentication identifier comprises at least one of: an encryption algorithm employed for security authentication, a certificate authority CA issuing the digital certificate, and a security mechanism corresponding to the digital certificate.

17. The apparatus according to claim 13, wherein the operation further comprises:
receiving, using the encryption subprocess, a digital certificate viewing instruction triggered for the security authentication identifier, and start a certificate viewer according to the digital certificate viewing instruction to display a content of the digital certificate.

18. The apparatus according to claim 17, wherein the operation of receiving, using the encryption subprocess, a digital certificate viewing instruction triggered for the security authentication identifier, and start a certificate viewer according to the digital certificate viewing instruction to display a content of the digital certificate comprises:
starting the certificate viewer using the encryption subprocess according to the digital certificate viewing instruction, respectively set up a general tab and a detailed tab in the certificate viewer, load general information of the digital certificate in the general tab, and load detailed information of the digital certificate in the detailed tab.

19. The apparatus according to claim 14, wherein the operations further comprise:
popping up a certificate selection box using the encryption subprocess when performing two-way authentication of the digital certificate, display, in the certificate selection box, information of each user certificate loaded in a terminal where the browser is, and receive the user certificate selected by a user via the certificate selection box.

20. The apparatus according to claim 13, wherein the operations further comprises:
displaying, a password entering message by the encryption subprocess, the password entering message being used for reminding a user to enter a protection password corresponding to the user certificate, receive, by the encryption subprocess, the protection password entered by the user, verify the protection password, and confirm the protection password to confirm that the user has a permission of using the user certificate.

21. (canceled)

22. The apparatus according to claim 19, wherein the operation of popping up a certificate selection box using the encryption subprocess when performing two-way authentication of the digital certificate, display, in the certificate selection box, information of each user certificate loaded in a terminal where the browser is, and receive the user certificate selected by a user via the certificate selection box comprises:
reminding, by the encryption subprocess via prompt information, the user to insert a security key storage hardware, the security key storage hardware storing the user certificate; invoke a driver program by the encryption subprocess to detect the security key storage hardware; and acquire, by the encryption subprocess, information of the user certificate stored in the security key storage hardware after detecting the security key storage hardware.

23. (canceled)

24. A non-transitory computer-readable medium, having computer programs stored thereon that, when executed by one or more processors of a computing device, cause the computing device to perform operations comprising:
receiving a website address entered by a user via an address bar of a browser;
performing security authentication of a digital certificate according to an authentication type of a network server corresponding to the website address, wherein the digital certificate is issued by a certificate authority CA; and
loading a security authentication identifier corresponding to the security authentication into the address bar of the browser after the security authentication has been passed.
